(19) United States
(12) Patent Application Publication
(10) Pub. No.: US 2011/0276872 A1
(43) Pub. Date: Nov. 10, 2011

(54) DYNAMIC FONT REPLACEMENT

(75) Inventors: Saurabh Kataria, Jind (IN); Luca Marchesotti, Grenoble (FR); Florent Perronnin, Domene (FR)

(73) Assignee: XEROX CORPORATION, Norwalk, CT (US)

(21) Appl. No.: 12/774,819

(22) Filed: May 6, 2010

(51) Int. Cl. G06F 17/21; G06F 17/00; G06F 3/048

(52) U.S. Cl. 715/234; 715/269; 715/764

(57) ABSTRACT

Automated font mapping is performed for one or more document fonts of a document to map the one or more document fonts to at least one replacement font. The font mapping is limited by at least one document-specific font mapping limitation. The document is rendered using the at least one replacement font. The automated font mapping may include performing a constrained optimization of an objective function measuring similarity of the one or more document fonts and the corresponding mapped at least one replacement font, the constrained optimization being constrained by at least one constraint embodying at least one document-specific font mapping limitation. The automated font mapping may include selecting a subset of the set of fonts available for the rendering based on the at least one document-specific font mapping limitation, and performing the optimization respective to the selected subset of the set of fonts available for the rendering.

### BACKGROUND

The following relates to the document printing arts, document display arts, document rendering arts, and related arts.

Documents that include text comprising characters, such as letters, numerals, Asian characters, or so forth, are typically stored with the characters represented by numerical codes or other abstract representations. When the document is rendered for display or printing, the text is converted to a suitable font for display on a screen, printing on a physical page, or other human perceptible rendering. The document includes font information such as font type, font size, font characteristics (e.g., underlining, italics, boldface, superscript or subscript, or so forth) as well as information sufficient to determine the placement of the rendered text on the screen, printed page, or other rendering space.

A popular type of document creation system is colloquially referred to as “what you see is what you get” or WYSIWYG. In WYSIWYG systems, the document is displayed during document creation in the same way it is expected to be finally displayed or printed. For text, this means that the text is shown using the font type, size, and characteristics selected by the human document creator. Toward this end, the WYSIWYG document creation application or software, such as a word processing application, document publishing software, web page development software, or so forth, includes a set of fonts that are available for selection and WYSIWYG display during the document creation process. Alternatively, the document creation application or software may operate at a lower level, in which the human user specifies the font type, size, and characteristics but does not see the document in a WYSIWYG format during the document creation process. An example of such a system is a LaTeX editor. Although a WYSIWYG interface is not included in such an application, the document creation application or software still provides a set of fonts that can be selected, and hence the final rendering including the font types is defined by the human user via the document creation application or software.

A document rendering system, such as a web browser, printing engine or related software or firmware, portable document format (PDF) file generator, or so forth, renders the created document for final display or printing. The document rendering system also typically includes a set of fonts that the rendering system is capable of rendering.

Modern document creation and rendering systems typically include hundreds, thousands, tens of thousands, or more available fonts. However, it sometimes arises that a font used in a created document is unavailable to the rendering system. In such cases, it is known to perform a font replacement (also referred to as font mapping) in which the unavailable font is replaced by an available similar font for the final document rendering. Toward this end, various automated font similarity metrics exist, for example as disclosed in Martin Solli, “Topics on Content Based Image Retrieval—Fonts and Color Emotions”, Thesis No. 1397, Linköping University (February 2009, Document LIU-TEK-LIC-2009:5, available at http://liu.diva-portal.org/smash/get/diva2:174885/FULLTEXT01, last accessed Mar. 4, 2010), which is incorporated herein by reference in its entirety, which can be used to automatically select a similar font as measured by the metric. The mapping may be generated on demand—for example, when the rendering application encounters an unavailable font in a document the similarity measure may be applied to locate a similar replacement font that is available to the rendering engine. Alternatively, the mapping may be generated a priori based on the font similarity measures and stored as a lookup table—then, when an unavailable font is encountered the replacement font is immediately identified (i.e., mapped) by reference to the lookup table.

The following discloses improved font mapping methods and apparatuses.

### BRIEF DESCRIPTION

In some illustrative embodiments disclosed as illustrative examples herein, a method comprises performing automated font mapping for one or more document fonts of a document to map the one or more document fonts to at least one replacement font, and rendering the document using the at least one replacement font, wherein the font mapping is limited by at least one document-specific font mapping limitation.

In some illustrative embodiments disclosed as illustrative examples herein, in the method of the immediately preceding paragraph the automated font mapping includes performing a constrained optimization of an objective function measuring similarity of the one or more document fonts and the corresponding mapped at least one replacement font, the constrained optimization being constrained by at least one constraint embodying at least one document-specific font mapping limitation. In some illustrative embodiments disclosed as illustrative examples herein, in the method of the immediately preceding paragraph the automated font mapping includes selecting a subset of the set of fonts available for the rendering based on the at least one document-specific font mapping limitation, and performing an optimization of an objective function measuring similarity of the one or more document fonts and the corresponding mapped at least one replacement font, the optimization being respective to the selected subset of the set of fonts available for the rendering.

In some illustrative embodiments disclosed as illustrative examples herein, a system comprises: an automated font mapping sub-system embodied by a digital processing device and configured to map one or more document fonts of a document to at least one replacement font with the mapping limited by at least one document-specific font mapping limitation; and a rendering sub-system configured to render the document using the at least one replacement font.

### BRIEF DESCRIPTION OF THE DRAWINGS

FIG. 1 diagrammatically shows a document processing system including font replacement as disclosed herein.

FIG. 2 diagrammatically shows an illustrative implementation of the document processing system employing an application program plug-in.

FIGS. 3-5 diagrammatically show illustrative user interface displays suitably generated by the system of FIG. 1 during font replacement processing.

### DETAILED DESCRIPTION

It is recognized herein that a disadvantage of existing font mapping approaches that select a replacement font based on a font similarity measure is that these mapping approaches generally operate globally, without reference to the particular document being rendered. That is, document-specific considerations are not taken into account. This has generally not been considered to be problematic, since selection of a most similar font, as measured by a suitable font similarity metric, is expected to provide an optimal result.

However, it is recognized herein that in some document-specific instances, this is not the case. For example, in some documents different fonts are intentionally used to represent different types of textual content. By way of just one illustrative example, in a script for a play, dialog content attributed to different actors may be distinguished by using different fonts. If the font mapping maps these different document fonts to a single most similar replacement font, then relevant information encoded by the use of different document fonts is lost. Another document-specific consideration may be rendering cost. Some fonts may be copyrighted or otherwise proprietary, and the use of such a font in the document may incur a licensing fee, which may for example be charged on a per printout, per document download, per page, or other basis. Thus the licensing cost depends on the number of document pages, number of copies of the document to be printed, the number of anticipated document downloads, or other document-specific information.

Other document-specific considerations may urge against the use of certain fonts for a given document. For example, a set of proprietary fonts may only be licensed for a particular class of applications or users, and should not be used for documents that do not fall within that class. Certain fonts may also be undesirable due to their size. For example, a font that makes a rendered text unit too large to fit in an allocated space (as measured, for example, by a line or number of lines, a page or number of pages, or so forth) may be undesirable.

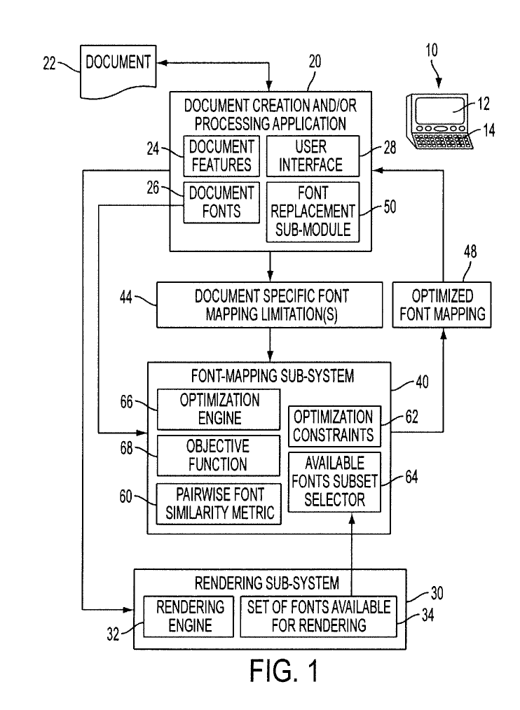

With reference to FIG. 1, a document processing system with improved font replacement is disclosed. The document processing system is suitably implemented by one or more computers, such as an illustrative computer 10 having a display 12 or other user interfacing output device and a keyboard 14, mouse (not shown), or other user interfacing input device. The one or more computers may include one or more desktop computers, one or more notebook computers, one or more network servers, one or more Internet servers, or various combinations thereof. It is also contemplated to implement a portion or all of the document processing system on one or more other digital processing devices, such as a marking engine (for example, a multifunction printing device with digital processing capability).

With continuing reference to FIG. 1, a document creation and/or processing application 20 suitably implemented on the computer 10 or another digital processing device or cooperating group of digital processing devices creates or processes a document 22 that includes textual content. As part of the creation/processing of the document 22, the application 20 quantifies document features 24 such as total number of pages, total number of paragraphs, or so forth. The application 20 also tracks the set of document fonts 26 that are used in the document 22. The document fonts 26 may include fonts that are allowed to be replaced, or embedded fonts in which the font is stored with or transmitted with the document so that the embedded font is always available for the rendering.

The application 20 also implements a user interface 28 via which a human user may interact with the application 20 to create, modify, print, or otherwise manipulate the document 22. In some embodiments, the user interface 28 is a graphical “what you see is what you get” or WYSIWYG interface that displays a rendering of the document 22 using the document fonts 26 on the display 12 of the computer 10. In other embodiments the user interface is a text-based or other interface.

At some point, the document 22 is to be rendered. As used herein, the term “rendering” encompasses physical printing of the document and also encompasses rendering of the document 22 into a print-ready format such as a portable document format (PDF) file, a Postscript (PS) file, or so forth. Toward this end, a rendering sub-system 30 is provided. The rendering sub-system 30 may include a marking engine that generates physical printing of the document 22, or the rendering sub-system 30 may be a software-only component such as a PDF file generator. In either case, the rendering sub-system 30 includes a rendering engine 32 that converts the document 22 into a print-ready format. The rendering engine 32 may be embodied by the computer 10 or by another digital processing device. For example, in the case of a multifunction printing device the rendering engine 32 may be embodied in whole or in part by a dedicated processor of the multifunction printing device, and/or may be embodied in whole or in part by a server computer that generates the print-ready file, or so forth. The rendering system 30 also includes or has access to a set of fonts 34 available for the rendering. Some or all fonts of the set of fonts 34 may be stored at the rendering system 30 (for example, in memory of a multifunction printing device). Some or all fonts of the set of fonts 34 may be stored remotely from the rendering system 30, for example at a server accessible via a digital network or the Internet.

The set of fonts 34 available for rendering in general may be different from a set of fonts available to the document creation/processing application 20, and so the document fonts 26 may include one or more fonts that are not included in the set of fonts 34 available for rendering. Typically, such unavailable fonts cannot be rendered.

In some cases the document font may be an embedded font that is embedded with the document 22 and is conveyed with the document to the rendering sub-system 30. If the rendering sub-system 30 is capable of processing the embedded font, then the embedded font can be rendered even though it is not included in the set of fonts 34. This does not always work, however, because the embedded font may be embedded in a format that is not decipherable by the rendering sub-system 30. If the rendering sub-system 30 is not capable of processing the embedded font (and the embedded font is not included in the set of fonts 34), then the embedded font cannot be rendered by the rendering sub-system 30 in spite of its being embedded with the document 22.

Thus, one reason why a document font may be replaced for the rendering is that the document font may be unavailable for rendering. However, even if a font of the document fonts 26 is available in the set of fonts 34 or is embedded in a format readable by the rendering sub-system 30, it may nonetheless be desirable to map the document font to a replacement font for some other reason, such as: to personalize the document; to improve readability for persons with limited eyesight; to reduce font licensing costs; to ensure compliance with an organizational uniformity standard that specifies the fonts to be used for certain document types; or so forth.

In view of the foregoing, a font mapping sub-system 40 is provided, which performs font mapping respective to a set of fonts to be mapped. The set of fonts to be mapped may include one, two, more than two, or all of the document fonts 26. The mapping is to replacement fonts selected from the set of fonts 34 available for rendering. The font mapping sub-system 40 also optionally receives one or more document-specific font mapping limitations 44. By way of illustrative example, these limitations 44 may include: a requirement that each font be mapped to a different replacement font; a constraint on printing cost (for example, this may be affected by font licensing fees); a limitation on rendered font size (for example, quantified by requiring that single-line titles remain at a single line of rendered text); or so forth.

The output of the font mapping sub-system 40 is an optimized font mapping 48 that indicates, for each document font to be mapped, a replacement font optimally selected from the set of fonts 34 available for rendering. The optimized font mapping 48 is optionally reviewed and validated or modified by a human user via the user interface 28 of the application 20. After the optional validation, the optimized font mapping 48 is processed at the application 20 by a font replacement sub-module 50. If a replacement font is available at the application 20, then the font replacement sub-module 50 updates any WYSIWYG rendering at the application 20 to use the replacement font as specified by the font mapping 48. If a replacement font is not available at the application 20, then the font replacement sub-module 50 optionally attempts to obtain the missing replacement font by downloading from a fonts database or other source, and then updates the WYSIWYG rendering. If a replacement font is not available at the application 20 and cannot be obtained, then the replacement is not performed but any WYSIWYG rendering is preferably flagged with an annotation indicating that due to the missing replacement font the WYSIWYG rendering may not precisely show the printout, PDF file, or other rendering. In any case, when the document 22 is sent to the rendering sub-system 30 for rendering (i.e., printing, PDF file generation, PS file generation, or so forth) the font mapping 48 is suitably included to specify any replacement font or fonts for use in the rendering.

With continuing reference to FIG. 1, the font mapping sub-system 40 is now further described. The font mapping sub-system 40 performs document-specific font mapping, in which one or more document fonts 26 of the document 22 are mapped to at least one replacement font, wherein the font mapping is limited by at least one document-specific font mapping limitation 44. The font mapping takes into account visual similarity between the document fonts 26 and their replacements (as measured by a pairwise font similarity metric 60), and also takes into account the document-specific font mapping limitation or limitations 44.

The pairwise font similarity metric 60 is suitably embodied by a similarity metric of the form s(i, π(i)) where i denotes the document font and π(i) denotes a (candidate) mapping to a replacement font such that π(i) denotes the (candidate) replacement font under consideration. The similarity metric s(−,−) can be embodied in various ways. In some embodiments, a standard sample text written in each font i, π(i) is processed to extract a set of features (e.g., a features vector) whose elements represent selected quantitative characteristics of the standard sample text, and the function s(−,−) receives the set of features for the font i and the font π(i) and computes a similarity or distance (e.g., a cosine similarity, a Euclidean distance, or so forth) or other comparison measure between these features vectors. In other embodiments, the function s(−,−) is embodied as a look-up table that tabulates similarity values for pairs of fonts. Such a look-up table can be computed using a distance metric or the like, or alternatively can be generated manually, for example based on subjective human judgments about the similarities or dissimilarities of pairs of fonts. Moreover, it is noted that the similarity function s(−,−) can be either a continuous function (as, for example, is obtained using a cosine similarity) or can be a discontinuous or discrete function.

In an illustrative embodiment, a feature vector is computed for a font as follows. Each symbol of a character set (for example, the character set {A-Z, a-z, 0-9} is electronically rendered by generating a bitmap of the rendered character, and a set of features is computed for each bitmap. In one approach, the features are 128-dimensional histograms of gradient orientations. The set of per-letter features are then concatenated to obtain a features vector representing the font. The function s(i,π(i)) measures a similarity (e.g., a cosine similarity) of the features vectors representing the fonts i,π(i).

Some of the document-specific font mapping limitations 44 may be suitably represented as optimization constraints 62. For example, a limitation comprising an upper limit on licensing fees for printing the document can be represented as an upper bound constraint on the font mapping optimization. By way of another illustrative example, a limitation barring the mapping of two different document fonts to the same replacement font can be represented as a lower limit on the total number of different replacement fonts.

Some of the document-specific font mapping limitations 44 may be better represented by filtering the set of replacement fonts under consideration. Toward this end, the font mapping sub-system 40 includes an available fonts subset selector 64 that selects a subset of the set of fonts 34 available for rendering for use in the font mapping. For example, the available fonts subset selector 64 may exclude from the selected subset of available replacement fonts certain fonts that are not allowed for use in printing of documents of a document type to which the document 22 belongs.

In a suitable embodiment, the font mapping sub-system 40 includes an optimization engine 66 that performs the font mapping by performing a constrained optimization of an objective function 68 measuring similarity of the document fonts to be mapped and the corresponding mapped at least one replacement font, with the constrained optimization being constrained by the one or more optimization constraints 62 embodying one or more of the document-specific font mapping limitations 44. The constrained optimization is respective to a subset of the set of fonts 34 available for rendering, in which the subset is selected by the selector 64 based on one or more of the document-specific font mapping limitations 44.

An illustrative embodiment of font mapping suitably performed by the font mapping sub-system 40 is as follows. Let f denote the set of document fonts 26 to be mapped, and let F denote the subset of the set of fonts 34 available for the rendering selected by the available fonts subset selector 64. Thus, F is either coextensive with the set of fonts 34 available for the rendering, or is a selected subset of the set of fonts 34 available for the rendering. The intersection between f and F may or may not be an empty set. Let π:f→F denote a (candidate) font mapping. Let π:f→F denote the optimized font mapping 48 that is to be determined by the font mapping sub-system 40.

The objective function 68 measures the similarity between the set of document fonts f to be mapped and the (candidate) set of replacement fonts F. Let s: f×F→R be a function which measures the similarity between a document font to be mapped and a replacement font of the set of replacement fonts F. Let s(i,π(i)) denote the similarity between document font i and its (candidate mapped) replacement font π(i). A suitable embodiment of the objective function 68 is:

$${max}_{π} {\sum }_{i ∈ f} s ( i , π ( i ) ) . \qquad ( 1 )$$

The optimized font mapping 48 can then be written as the following constrained optimization:

$${π}_{opt} = {arg max}_{π} {\sum }_{i ∈ f} s ( i , π ( i ) ) subject to \{ g ( f , π ) \} . \qquad ( 2 )$$

where {g(f,π)} denotes the set of optimization constraints 62. Equations (1) and (2) assume that the similarity measure s(i,π(i)) is increasing, that is, that a larger value of s(i,π(i)) indicates greater similarity between document font i and its (candidate) replacement font π(i). If, on the other hand, s(i,π(i)) is decreasing such that a smaller value of s(i,π(i)) indicates greater similarity between fonts i and π(i), then the max and arg max terms of Equations (1) and (2) are suitably replaced by min and arg min terms.

As used herein, terms such as “optimized” and “maximum” and “minimum” are to be understood as encompassing outputs generated by automated optimization or automated maximization or automated minimization algorithms wherein those outputs may not necessarily be a global optimum, maximum, or minimum. For example, solving Equation (1) may generate a local maximum value for the objective function. As is known in the art, such local extrema may be acceptable, or alternatively if the local extremum is not acceptable the optimization (or maximization or minimization) may be rerun using different starting values to obtain a better result.

Some illustrative constraints suitably included in the set of constraints {g(f,π)} are as follows.

One optionally included constraint ensures that there are the same number of fonts in the document 22 before and after the font mapping. That is, two document fonts cannot be mapped to the same replacement font. This constraint can be expressed as follows:

π(i)≠π(j), ∀i≠j where i∈f and j∈f (3).

Equation (3) assumes that all document fonts of the set of document fonts 26 are being mapped, that is, assumes that f includes all document fonts of the set of document fonts 26. If this is not the case, then let [symbol] f denote the set of those document fonts of the set of document fonts 26 that are not being mapped, that is, that are not included in f. Thus, the set of document fonts 26 is the union of f and [symbol] f, and the intersection of f and [symbol] f is empty. With these definitions, Equation (3) can be generalized to:

π(i)≠π(j)∀i≠j and π(i)∉ [symbol] f, where i∈f and j∈f (3′).

One way to implement the second term (π(i)∉ [symbol] f) is to employ the available fonts subset selector 64 to omit any font in the set [symbol] f from the set of possible replacement fonts F, after which the constraint of Equation (3) can be employed. In other words, Equation (3) can be employed with the set of fonts [symbol] f, being made unavailable as possible replacement fonts.

Another optionally included constraint relates to licensing cost. As some fonts come with a licensing fee, it may be desirable to cap the total licensing fee for the new document. Let c(π(i)) be the cost associated with a given (candidate) replacement font π(i), and let C be the upper-bound on the cost, where the cost is measured in U.S. dollars, EU euros, or another suitable monetary unit or equivalent. The total licensing cost constraint can be written as:

$${\sum }_{i ∈ f} c ( π ( i ) ) \leq C . \qquad ( 4 )$$

If not all document fonts of the set of document fonts 26 are to be mapped (that is, if the set [symbol] f is not empty), then the constraint can be written as:

$${\sum }_{i ∈ f} c ( π ( i ) ) \leq {C}^{′} , \qquad ( {4}^{′} )$$

where C′ is given by:

$${C}^{′} = ( C - {\sum }_{l ∈ f} c ( l ) ) , \qquad ( 5 )$$

where the subtracted term in Equation (5) does not depend upon the mapping π and thus C′ can be pre-calculated prior to performing the optimization.

The cost c(m) for a font in may be fixed for a given document (that is, a per-document license fee). On the other hand, the cost c(m) may also be functionally dependent on a document parameter quantifying usage of the font in in the rendering of the document. For example, the document parameter quantifying usage of the font m in the rendering of the document may be a number of document pages in the rendering of the document, a number of document copies in the rendering of the document, a number of document pages times a number of document copies in the rendering of the document, or so forth.

As already noted, some document-specific font mapping limitations are better implemented by having the available fonts subset selector 64 select the set of possible replacement fonts F as a subset of the set of fonts 34 available for the rendering. As already noted with reference to Equation (3′), one place where this is useful is in implementing the limitation that the number of fonts should not be changed by the mapping, in the case where some document fonts are not mapped. In this case, the selector 64 omits from F any font that is a member of the set of unmapped document fonts [symbol] f.

Other document-specific font mapping limitations that are suitably implemented by the available fonts subset selector 64 are size limitations on the replacement fonts. For example, a document-specific limitation may be that a given portion of the text should fit into an allotted space. By way of illustrative example, it may be desired to enforce the limitation that a title should fit on a single line, or that a paragraph should fit into a specified number of lines (optionally plus or minus a further specified margin of few lines). To implement, the selector 64 suitably electronically renders the title (by way of example) using each font of the set of fonts 34 available for rendering, and if the rendered title is too long then the font is omitted from the set of possible replacement fonts F.

In some embodiments, the constrained optimization performed by the optimization engine 66 is performed by a linear programming (LP) algorithm. As shown herein, in some embodiments the constrained optimization can be performed by an integer linear programming (ILP) algorithm. By way of illustrative example, constrained optimization performed by a 0-1 linear programming (0-1 LP) algorithm is described, in which the objective function 68 is as set forth in Equation (2) with the set of constraints {g(f,π)} including the constraint of Equation (3) (with any unmapped fonts accommodated by employing the selector 64 to omit the unmapped fonts [symbol] f from F as previously described) and the constraint of Equation (4) or (4′). A 0-1 LP algorithm is a type of ILP in which the variables take binary values.

In describing the 0-1 LP, let M be the cardinality of the set of document fonts f to be mapped (that is, M is the number of fonts in the set of document fonts f), and let N be the cardinality of the set of possible replacement fonts F. The mapping i→π(i) of a given document font i∈f to a (candidate) replacement font π(i)∈F is suitably encoded using an N-dimensional binary vector vᵢ. This vector vᵢ a single non-zero value corresponding to index π(i). The global mapping of all document fonts f to be mapped can therefore be encoded as an M×N dimensional binary vector V by concatenating the vectors vᵢ for all i∈f. This concatenated vector V has exactly M non-zero values.

Further, let sᵢ denote the N-dimensional vector of similarities between document font i∈f and all fonts in F. Let S denote the M×N dimensional vector obtained by concatenating the M vectors sᵢ, i=1, . . . , M. With these definitions, the objective function of Equation (1) can be rewritten as:

$${max}_{v} {S}^{T} V , \qquad ( 6 )$$

where the superscript T denotes the transposition operation.

The constraint of Equation (3) can be encoded in the 0-1 LP formalism as follows. Let eₖ denote an N-dimensional binary vector with a single non-zero value at index k. Let Eₖ denote an M×N dimensional vector obtained by concatenating M instances of the vector eₖ. To ensure that no two fonts in f are mapped to the same font in F (which is the intent of the constraint of Equation (3)), the following 0-1 LP constraints are enforced: Eₖ^{T}V≦1, ∀k=1, . . . , N. Hence, enforcing the constraint of Equation (3) translates into enforcing N constraints in the 0-1 LP formalism.

The constraint of Equation (4) can be encoded in the 0-1 LP formalism as follows. Let γ denote an N-dimensional vector which contains the cost associated with each font of the set of possible replacement fonts F. Let γ denote an M×N dimensional vector obtained by concatenating M instances of the vector γ. To enforce the constraint of Equation (4), that is, to ensure that the total licensing fee cost is less than or equal to C, the following 0-1 LP constraint is enforced: Γ^{T}V≦C. Analogously, in the case where the set of unmapped fonts [symbol] f is not empty, that is, in the case of Equation (4′), the 0-1 LP constraint Γ^{T}V≦C′ is enforced.

Maximizing the objective function of Equation (6) under the constraint(s) Eₖ^{T}V≦1, ∀k=1, . . . , N and/or Γ^{T}V≦C (or Γ^{T}V≦C′) is a 0-1 LP problem. This is an NP-hard problem for which there does not exist a general algorithm which can solve the problem in polynomial time. However, methods based on relaxation and branch-and-bound algorithms are suitably used to optimize this objective function exactly or approximately. See, e.g. “Linear programming relaxation”, http://en.wikipedia.org/wiki/Linear_programming_relaxation (last accessed Feb. 17, 2010).

Some document-specific font mapping limitations are suitably implemented by the available fonts subset selector 64. By way of illustrative example, consider one particular constraint, namely that all titles should fit on a single line. To implement this limitation for a title in the document 22 that is written in a document font i, the title is electronically rendered using each font of the set of fonts 34 available for rendering. Any fonts for which the electronically rendered title occupies two or more lines are omitted from the set of possible replacement fonts F by the selector 64. This does not affect the 0-1 LP implementation, except to reduce the size of the search space (that is, to reduce the cardinality N of the set of possible replacement fonts F, which reduces the computational cost of the 0-1 LP implementation).

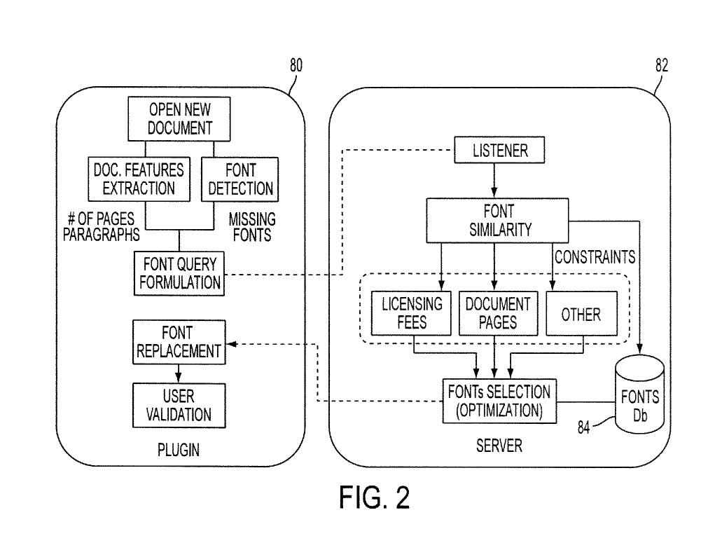

With reference to FIG. 2, an illustrative implementation employing an application program plug-in is diagrammatically illustrated. The system of FIG. 2 includes: a plug-in 80 installed into a user's web browser or other document editor (for example, Microsoft Word or Adobe Acrobat); a central server 82 performing computations and managing a web service able to respond to requests for font replacement; and a database of fonts 84 located at the server 82, as illustrated, or accessible by the server 82. The database of fonts 84 are indexed with pre-computed features and annotated with textual tags.

The plug-in 80 performs the document and font analysis functions of the document creation/processing application 20 of FIG. 1 for the document 22. All fonts (or references to the embedded fonts) used within the document 22 are extracted. Also features at a document level such as total number of pages, number of paragraph, or so forth, are computed. The plug-in 80 also performs query formulation. A request for font replacement is formulated if a font in the list of fonts detected in the document is missing or if the user is willing to launch a replacement session. In the latter case, the user is optionally given the option to parameterize the font replacement session explicitly, for example by specifying a maximum licensing fee.

At the server 82, listener functionality is provided. The illustrative server 82 is a web server. A web application run by the server 82 waits for connections on a predefined port. This application is capable of making queries on the database of fonts 84 and to initiate the optimization procedure. The server 82 also provides the font similarity assessment functionality, analogous to the pairwise font similarity metric 60 of the font mapping sub-system 40 of FIG. 1. Given two fonts, a numerical value indicating the visual similarity between the fonts is calculated using visual features and a simple distance measure.

The plug-in 80 or the server 82, or both, provide document-specific limitations configuration functionality. A set of limitations are configured as constraints (analogous to the optimization constraints 62 of FIG. 1) and/or as font selection criteria (of the type implemented by the available fonts subset selector 64 of FIG. 1). The constraints or selection criteria are configured manually or automatically, depending on the type of constraint. Typical constraints include licensing fee limits expressing a maximum per document cost that a user is prepared to spend to publish the document. Other constraints are suitably expressed automatically, such as the total number of pages that must be preserved after the font replacement operation.

The server 82 provides the font mapping (i.e., replacement font selection) functionality. The replacement fonts are computed using an optimization (as described herein with reference to the font-mapping sub-system 40 of FIG. 1) that maximizes the objective function 68 under the constraints 62. In illustrative embodiments disclosed herein, the optimization is suitably formulated as a 0-1 Linear Programming (0-1 LP) problem. The selected fonts are communicated from the server 82 to the plug-in 80 that formulated the request.

At the plug-in 80, the font replacement functionality is provided. The fonts to be replaced are replaced with the replacement fonts suggested by the server 82. If the replacement fonts are not available in the user's machine, the plug-in asks for permission to download the missing fonts.

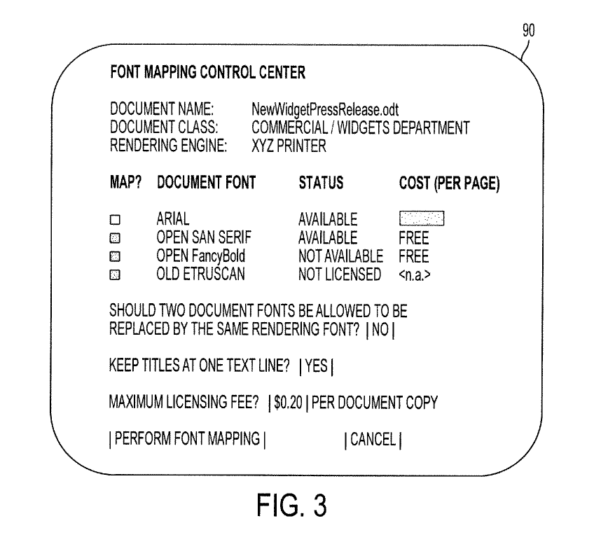

With reference to FIG. 3, a user interface dialog window 90 is shown, which is suitably employed by the user interface 28 of FIG. 1 to acquire user-provided information defining document-specific font mapping limitations. At the top of the dialog window 90 the document name, document class, and rendering engine are specified. The document class optionally provides a document-specific criterion for replacement font filtering applied by the available fonts subset selector 64. By way of illustrative example, the illustrative document class of “Commercial/Widgets Department” may provide a basis for omitting from the set of possible replacement fonts F certain fonts that are not allowed to be used for commercial purposes. The rendering engine typically determines the set of fonts 34 available for rendering.

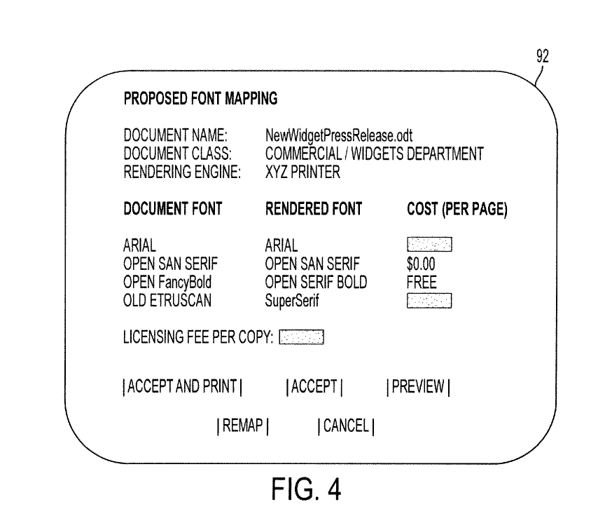

The dialog window 90 also lists the document fonts together with their status (“Available”, “Not available”, or “Not licensed”) and a per-page licensing cost, if applicable (note that in FIGS. 3 and 4, non-zero font licensing costs are diagrammatically indicated by filled boxes rather than by quantitative values). The leftmost column of this list also provides a selection box by which the user can select whether each font is to be mapped. Thus, in this illustrative example the set of fonts f to be mapped include the three fonts “Open San Serif”, “Open FancyBold”, and “Old Etruscan”, while the set of fonts [symbol] f that are not to be mapped include a single font, namely “Arial”.

In an option shown below the list of document fonts, the user can select whether two document fonts should be allowed to be replaced by the same rendering font. This option is shown as selected to be “No”, which indicates that the constraint of Equation (3) is to be implemented (with the unmapped “Arial” font which belongs to [symbol] f being omitted from the set of possible replacement fonts F by action of the selector 64). The next option of “Keep titles at one line?” is currently selected as “Yes”. Thus, the selector 64 will also be used to omit from the set of possible replacement fonts F any font for which any one-line title of the document “NewWidgetPressRelease.odt” for which the font renders the title as two (or more) lines of text. The last user option is to specify a maximum license fee, which is shown as currently set to $0.20 per document copy.

With reference to FIG. 4, an illustrative example is shown of a user interface dialog window 92, which suitably displays the results of the font mapping performed in accordance with the inputs of the dialog window 90 of FIG. 3. The unmapped “Arial” font is shown as being “replaced” by “Arial” (thus implementing “not mapping” the Arial font). The “Open San Serif” font was available for mapping, but the optimized font mapping kept the Open San Serif font unchanged. The remaining two fonts are mapped to new fonts. At the bottom of the dialog window 92, the user is provided with several selectable options, including: “Accept and print”, “Accept” (which stores the font mapping but does not immediately print the document), “Preview” (which displays a rendering with the replacement fonts on the display 12 for user review), “Remap” (which returns to the dialog window 90 of FIG. 3), and “Cancel”.

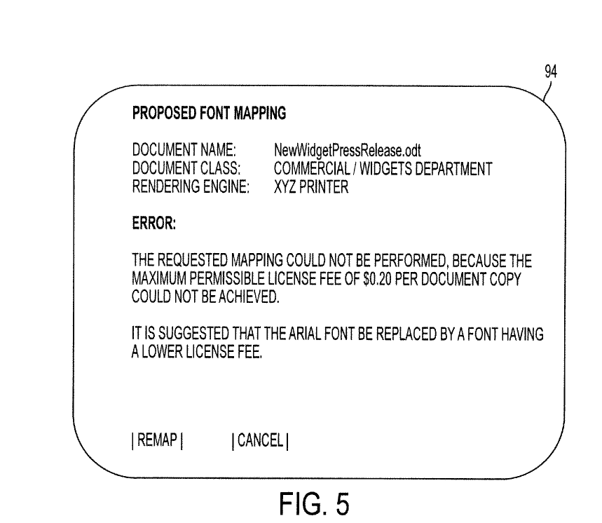

FIG. 5 illustrates another possible font mapping result. In this case, a dialog window 94 informs the user that: “The requested mapping could not be performed, because the maximum permissible license fee of $0.20 per document copy could not be achieved. It is suggested that the Arial font be replaced by a font having a lower license fee.” This dialog window 94 illustrates an advantage of the constrained optimization approach disclosed herein, namely that when the constrained optimization fails it can usually be determined which constraint was unable to be satisfied. In this case, the constraint of Equation (4′) was unable to be satisfied because the license fee of the unmapped Arial font (which impacts C′ in Equation (4′) as per Equation (5)) was too high. In the instant example, detection of the unachievable constraint may have been trivial if C′ was negative due to the licensing fee of the “Arial” font. At the bottom of the dialog window 94, the user is given the option of “Remap” (which returns to the dialog window 90 of FIG. 3) or “Cancel”.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
performing automated font mapping for one or more document fonts of a document to map the one or more document fonts to at least one replacement font; and
rendering the document using the at least one replacement font;
wherein the font mapping is limited by at least one document-specific font mapping limitation.

2. The method as set forth in claim 1, wherein the automated font mapping is performed by a digital processing device.

3. The method as set forth in claim 1, wherein the rendering is selected from a group consisting of displaying the document, printing the document, and generating a portable document format (PDF) file representation of the document.

4. The method as set forth in claim 1, wherein the performing automated font mapping comprises:
performing automated font mapping for M different document fonts of the document, where M is greater than or equal to two, to map the M different document fonts to M different replacement fonts;
wherein the at least one document-specific font mapping limitation includes requiring M different replacement fonts.

5. The method as set forth in claim 1, wherein the performing automated font mapping comprises:
performing a constrained optimization of an objective function measuring similarity of the one or more document fonts and the corresponding mapped at least one replacement font, the constrained optimization being constrained by at least one constraint embodying at least one document-specific font mapping limitation.

6. The method as set forth in claim 5, wherein the one or more document fonts consist of M different document fonts of the document, where M is at least two, and the at least one constraint includes a constraint that the at least one replacement font to comprise at least M different replacement fonts.

7. The method as set forth in claim 6, wherein the at least one constraint further includes an upper limit on a font licensing cost metric that is functionally dependent on the at least M different replacement fonts.

8. The method as set forth in claim 5, wherein the at least one constraint includes an upper limit on a font licensing cost metric that is functionally dependent on the at least one replacement font.

9. The method as set forth in claim 8, wherein the font licensing cost metric is also functionally dependent on a document parameter quantifying usage of the at least one replacement font in the rendering of the document.

10. The method as set forth in claim 9, wherein the document parameter quantifying usage of the at least one replacement font in the rendering of the document is selected from a group consisting of (1) a number of document pages in the rendering of the document, (2) a number of document copies in the rendering of the document, and (3) a number of document pages times a number of document copies in the rendering of the document.

11. The method as set forth in claim 5, wherein the constrained optimization is performed by a linear programming algorithm.

12. The method as set forth in claim 5, wherein the constrained optimization is performed by an integer linear programming algorithm.

13. The method as set forth in claim 5, wherein the constrained optimization is performed by a 0-1 linear programming algorithm.

14. The method as set forth in claim 5, wherein the performing of the constrained optimization comprises:
performing the constrained optimization respective to a subset of a set of fonts available for the rendering wherein the subset is selected based on the at least one document-specific font mapping limitation.

15. The method as set forth in claim 1, wherein the performing automated font mapping comprises:
selecting a subset of the set of fonts available for the rendering based on the at least one document-specific font mapping limitation; and
performing an optimization of an objective function measuring similarity of the one or more document fonts and the corresponding mapped at least one replacement font, the optimization being respective to the selected subset of the set of fonts available for the rendering.

16. The method as set forth in claim 15, wherein the selecting comprises:
omitting from the subset any font of the set of fonts available for the rendering for which a rendered selected text does not satisfy a rendered text size criterion.

17. The method as set forth in claim 15, wherein the selecting comprises:
omitting from the subset any font of the set of fonts available for the rendering having a license that does not permit its use in the document.

18. The method as set forth in claim 1, further comprising:
receiving the at least one document-specific font mapping limitation from a human user via a user interface device.

19. A system comprising:
an automated font mapping sub-system embodied by a digital processing device and configured to map one or more document fonts of a document to at least one replacement font with the mapping limited by at least one document-specific font mapping limitation; and
a rendering sub-system configured to render the document using the at least one replacement font.

20. The system as set forth in claim 19, wherein the rendering sub-system is selected from a group consisting of a display device, a marking engine, and digital processing device programmed to convert the document into a portable document format (PDF) file representation.

21. The system as set forth in claim 19, wherein the automated font mapping sub-system comprises:
a digital processing device configured to perform a constrained optimization of an objective function measuring similarity of the one or more document fonts and the corresponding mapped at least one replacement font, the constrained optimization being constrained by at least one upper or lower limit embodying at least one document-specific font mapping limitation.

22. The system as set forth in claim 21, wherein the one or more document fonts consist of M different document fonts of the document, where M is at least two, and the at least one upper or lower limit includes a lower limit of M on the number of replacement fonts comprising the at least one replacement font.

23. The system as set forth in claim 21, wherein the at least one upper or lower limit includes an upper limit on a font licensing cost metric that is functionally dependent on the at least one replacement font.

24. The system as set forth in claim 21, wherein the constrained optimization is performed by an integer linear programming algorithm.

25. The system as set forth in claim 19, further comprising:
a user interface device via which a human user inputs the at least one document-specific font mapping limitation.
